(19) United States
(12) Patent Application Publication
(10) Pub. No.: US 2018/0308002 A1
(43) Pub. Date: Oct. 25, 2018

(54) DATA PROCESSING SYSTEM WITH MACHINE LEARNING ENGINE TO PROVIDE SYSTEM CONTROL FUNCTIONS

(71) Applicant: Bank of America Corporation, Charlotte, NC (US)

(72) Inventors: Manu Jacob Kurian, Dallas, TX (US); Qishan Cai, Frisco, TX (US); Lixian Huang, Plano, TX (US); Jerzy Miernik, Allen, TX (US); Saritha Prasad Vrittamani, Plano, TX (US)

(21) Appl. No.: 15/492,545

(22) Filed: Apr. 20, 2017

(51) Int. Cl. G06N 99/00

(52) U.S. Cl. CPC G06N 99/005

(57) ABSTRACT

Systems for predicting system issues impacting one or more systems, devices, and/or applications are provided. A computing platform may generate one or more machine learning datasets. The one or more machine learning datasets may be generated based on data from various sources. In some arrangements, a content data stream may be received from one or more systems and may include current condition data associated with the system. The content data stream and/or other data may be compared to one or more machine learning datasets to predict a likelihood of an issue occurring or impacting one or more systems. If an issue is likely to occur, a monitoring rate may be adjusted in an effort to detect any issues as early as possible to enable remediation of the issues as quickly as possible. If an issue is not likely to occur, the monitoring rate or other setting may be maintained.

### BACKGROUND

Aspects of the disclosure relate to electrical computers, data processing systems, and machine learning. In particular, one or more aspects of the disclosure relate to implementing and using a data processing system with a machine learning engine to provide system control functions.

Large enterprise organizations may deploy, operate, maintain, and use many different computer systems, devices, applications, and the like, which may provide many different services. Maintaining these systems, devices, applications, and the like, in proper working order is a daunting task. For instance, monitoring a status of so many systems, devices, applications, and the like, can consume a vast number of computing resources. In particular, if each system, device, application, or the like, is continuously monitored, the number of computing resources to provide such monitoring may be virtually impossible. Alternatively, if an insufficient number of computing resources are assigned to monitor the systems, devices, and the like, issues may arise that are undetected or unresolved.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical problems associated with predicting system, device or application issues impacting one or more systems, devices, and/or applications.

In some examples, a system, computing platform, or the like, may generate one or more machine learning datasets. The one or more machine learning datasets may be generated based on data from various sources, including historical data associated with previous system issues, activities that occurred (e.g., file transfers, scheduled maintenance or updates, or the like) at or near the time an issue occurred, conditions associated with the system at or near the time the issue occurred, and the like.

In some arrangements, a content data stream may be received from one or more systems, devices, and/or applications. The content data stream may include current condition data associated with the system, device, and/or application. Other data may also be received. The content data stream and/or other data may be compared to one or more machine learning datasets to predict a likelihood of an issue occurring or impacting one or more systems.

If, based on the comparison, an issue is likely to occur, a monitoring rate, time interval associated with monitoring, start time of monitoring, or the like, may be adjusted in an effort to detect any issues as early as possible to enable remediation of the issues as quickly as possible. If, based on the comparison, an issue is not likely to occur, the monitoring rate or other setting may be maintained or unchanged from a current setting.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for implementing and using a data processing system with a machine learning engine to provide system control functions in accordance with one or more aspects described herein;

FIGS. 2A-2C depict an illustrative event sequence for implementing and using a data processing system with a machine learning engine to provide system control functions in accordance with one or more aspects described herein;

FIG. 3 depicts an illustrative method for implementing and using a data processing system with a machine learning engine to predict a likelihood that an issue will occur and modify one or more monitoring settings based on the predicted likelihood, according to one or more aspects described herein;

FIG. 4 depicts an illustrative user interface including a notification generated by the system monitoring and adjustment computing platform, according to one or more aspects described herein;

FIG. 5 depicts an illustrative method for implementing and using a data processing system with a machine learning engine to predict a likelihood that an issue will occur and adjusting or maintaining a monitoring setting based on the prediction, according to one or more aspects described herein;

FIG. 6 illustrates one example operating environment in which various aspects of the disclosure may be implemented in accordance with one or more aspects described herein; and

FIG. 7 depicts an illustrative block diagram of workstations and servers that may be used to implement the processes and functions of certain aspects of the present disclosure in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Some aspects of the disclosure relate to using machine learning to predict a likelihood that an issue may occur or impact one or more systems and adjusting a monitoring rate of the system, time interval during which the system is monitored, or the like, based on the predicted likelihood that an issue may occur or impact the one or more systems.

In conventional systems, monitoring systems, generating notifications related to monitored systems, and the like, have static settings across servers in a network. In dynamic business environments, these static settings are not conducive to optimizing computing resources during changing network conditions. For instance, static monitoring settings may require one or more systems to be constantly monitored to identify potential issues. This arrangement likely requires more computing resources than necessary because the system is being constantly monitored, rather than monitored during times when it is likely that an issue will occur. In another example, a system may be monitored throughout the business day but after business hours might not be monitored. This may lead to issues remaining undetected and/or unresolved if an issue occurs outside of business hours.

Accordingly, aspects described herein provide for the use of machine learning to predict a likelihood of an issue occurring or impacting one or more systems and adjusting a monitoring rate, time at which monitoring begins, time interval during which a system is monitored, or the like, based on the predicted likelihood. For example, historical data related to one or more system issues that previously occurred (and, in some examples, has been resolved), conditions associated with a particular system when an issue occurred, external factors such as date, time, day of week, day of month, month end, quarter end, year-end, or the like, when one or more issues occurred, and/or activities that occurred at or near the time of issues that previously occurred (e.g., file transfers of files having large file sizes (e.g., file size above a predetermined file size threshold), scheduled maintenance or updates, or the like), may be used to generate one or more machine learning datasets. The machine learning datasets may then be compared to current conditions of one or more systems received via a real-time content data stream to predict a likelihood of an issue occurring or impacting one or more systems.

In some examples, if it is determined that an issue is likely to occur or impact one or more systems, a monitoring rate, time at which monitoring begins, time interval during which a system is monitored, or the like, may be adjusted. If an issue is not likely, the monitoring rate and/or other settings may remain at a current setting until the process is repeated. Accordingly, data from systems is being evaluated on a rolling basis to update monitoring settings for current conditions of the system, network, and the like. This provides a flexible and customizable approach to monitoring systems for issues.

In some examples, evaluation of a system may include identifying one or more systems upstream or downstream of the system being evaluated to identify a potential issue or impact. For instance, evaluation of a first system may indicate that while an issue may occur that may impact the first system, one or more upstream or downstream systems may also be impacted. Accordingly, a monitoring rate for the one or more upstream and/or downstream systems may also be adjusted.

These and various other arrangements will be discussed more fully below.

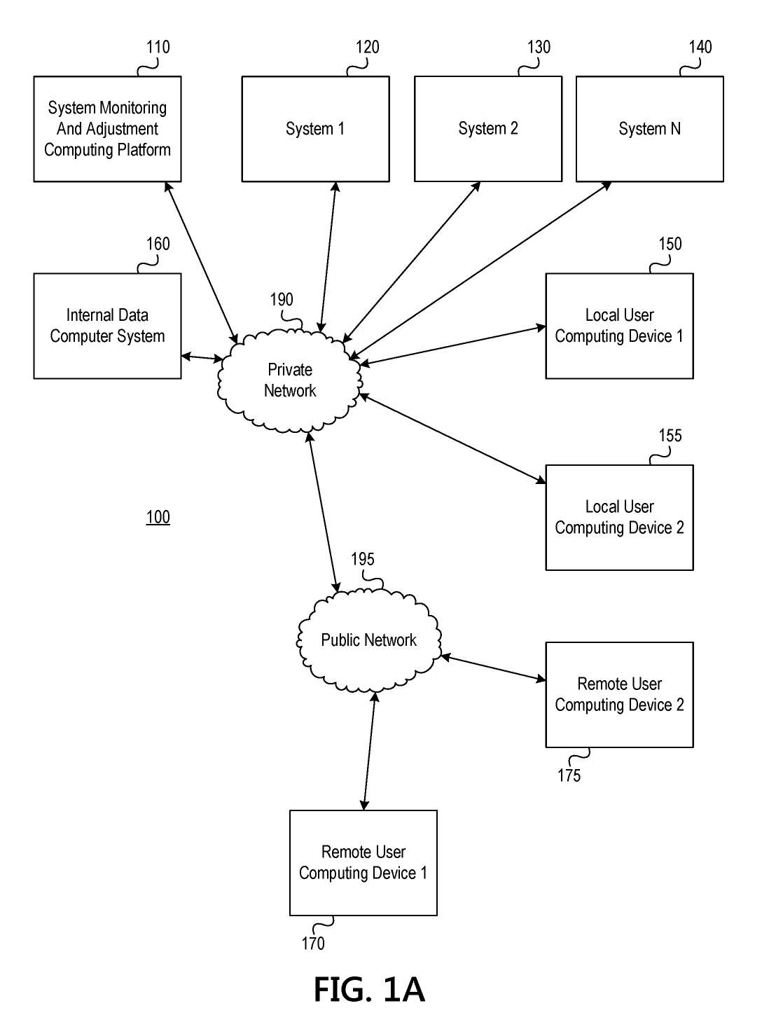

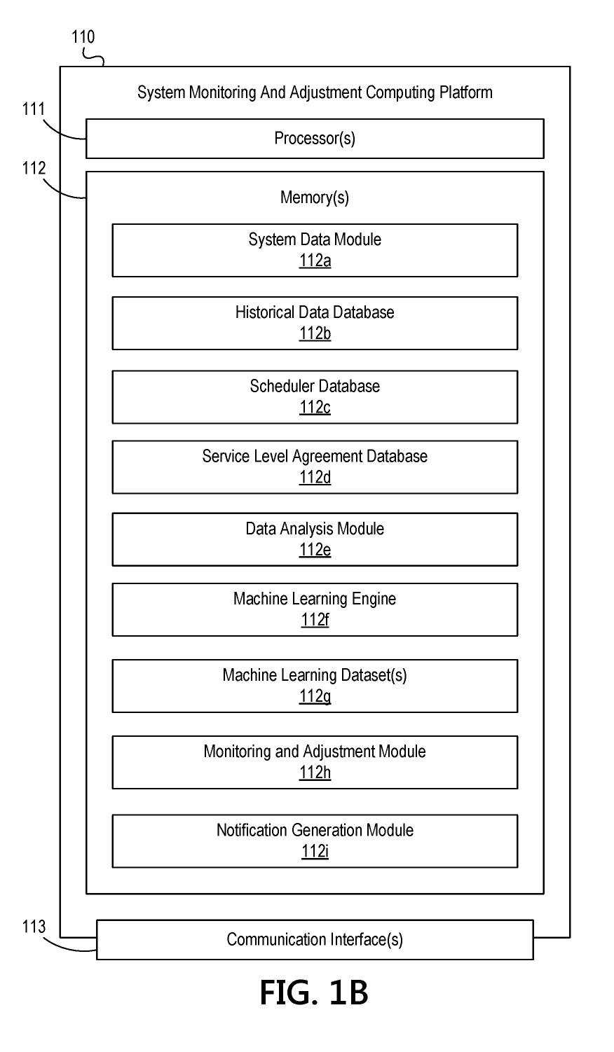

FIGS. 1A and 1B depict an illustrative computing environment for implementing and using a data processing system with a machine learning engine to provide system monitoring and adjustment functions in accordance with one or more aspects described herein. Referring to FIG. 1A, computing environment 100 may include one or more computing devices and/or other computing systems. For example, computing environment 100 may include a system monitoring and adjustment computing platform 110, a first system 120, a second system 130, an Nth system 140, an internal data computer system 160, a first local user computing device 150, a second local user computing device 155, a first remote user computing device 170, and a second remote user computing device 175.

System monitoring and adjustment computing platform 110 may be configured to host and/or execute a machine learning engine to provide automated system monitoring functions, adjustment of monitoring rates, and the like, as discussed in greater detail below. In some instances, system monitoring and adjustment computing platform 110 may monitor one or more systems, such as system 120, 130, 140 to predict a likelihood that an issue will occur and modify a rate, time, or the like, at which the system is monitored (e.g., to identify potential issues) to attempt to identify any issues quickly and address issues efficiently. One or more notifications may be transmitted to a system, user computing device, or the like, either identifying a likelihood of issue, identifying a modified monitoring rate, or identifying an issue identified via monitoring. In some examples, the notifications may include information about the issue, steps to implement or avoid or mitigate an issues, or the like. Accordingly, upon receipt of a notification, one or more steps may be implemented (in some examples, automatically) to avoid or mitigate an issue.

System 1 120, system 2 130, and/or system N 140, may be any type of system, device, application, or the like, monitored by the system monitoring and adjustment computing platform 110. For instance, the systems may be one or more of servers, applications executing on one or more devices, other computing platforms, and the like. The systems being monitored may, in some examples, be systems and the like, significant to a business or entity employing the system monitoring and adjustment functions. Accordingly, early identification and remediation of issues may be critical to the business. In addition, large enterprise organizations may have thousands or tens of thousands of systems, devices, applications, or the like, being monitored.

Internal data computer system 160 may be configured to monitor, collect, store and/or transmit data related to historical system data, current date and time data, historical file transmission data, historical system outage and remediation data, and the like. The internal data computer system 160 may include one or more databases configured to store data and transmit data, as requested, to, for instance, the system monitoring and adjustment computing platform 110.

Local user computing device 150, 155 and remote user computing device 170, 175 may be configured to communicate with and/or connect to one or more computing devices or systems shown in FIG. 1A. For instance, local user computing device 150, 155 may communicate with one or more computing systems or devices via network 190, while remote user computing device 170, 175 may communicate with one or more computing systems or devices via network 195. The local and remote user computing devices may be used to provide access one or more systems being monitored (e.g., from which data is collected), as well as to display one or more notifications, as will be discussed more fully below.

In one or more arrangements, system 1 120, system 2 130, system N 140, internal data computer system 160, local user computing device 150, local user computing device 155, remote user computing device 170, and remote user computing device 175 may be any type of computing device capable of performing the particular functions described herein. For example, system 1 120, system 2 130, system N 140, internal data computer system 160, local user computing device 150, local user computing device 155, remote user computing device 170, and remote user computing device 175 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of system 1 120, system 2 130, system N 140, internal data computer system 160, local user computing device 150, local user computing device 155, remote user computing device 170, and remote user computing device 175 may, in some instances, be special-purpose computing devices configured to perform specific functions.

Computing environment 100 also may include one or more computing platforms. For example, and as noted above, computing environment 100 may include system monitoring and adjustment computing platform 110. As illustrated in greater detail below, system monitoring and adjustment computing platform 110 may include one or more computing devices configured to perform one or more of the functions described herein. For example, system monitoring and adjustment computing platform 110 may include one or more computers (e.g., laptop computers, desktop computers, servers, server blades, or the like).

As mentioned above, computing environment 100 also may include one or more networks, which may interconnect one or more of system monitoring and adjustment computing platform 110, system 1 120, system 2 130, system N 140, internal data computer system 160, local user computing device 150, local user computing device 155, remote user computing device 170, and remote user computing device 175. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular organization (e.g., a corporation, financial institution, educational institution, governmental institution, or the like) and may interconnect one or more computing devices associated with the organization. For example, system monitoring and adjustment computing platform 110, system 1 120, system 2 130, system N 140, internal data computer system 160, local user computing device 150, and local user computing device 155 may be associated with an organization (e.g., a financial institution), and private network 190 may be associated with and/or operated by the organization, and may include one or more networks (e.g., LANs, WANs, virtual private networks (VPNs), or the like) that interconnect system monitoring and adjustment computing platform 110, system 1 120, system 2 130, system N 140, internal data computer system 160, local user computing device 150, and local user computing device 155 and one or more other computing devices and/or computer systems that are used by, operated by, and/or otherwise associated with the organization. Public network 195 may connect private network 190 and/or one or more computing devices connected thereto (e.g., system monitoring and adjustment computing platform 110, system 1 120, system 2 130, system N 140, internal data computer system 160, local user computing device 150, and/or local user computing device 155) with one or more networks and/or computing devices that are not associated with the organization. For example, remote user computing device 170 and remote user computing device 175 might not be associated with an organization that operates private network 190 (e.g., because remote user computing device 170 and remote user computing device 175 may be owned, operated, and/or serviced by one or more entities different from the organization that operates private network 190, such as one or more customers of the organization and/or vendors of the organization, rather than being owned and/or operated by the organization itself or an employee or affiliate of the organization), and public network 195 may include one or more networks (e.g., the internet) that connect remote user computing device 170 and remote user computing device 175 to private network 190 and/or one or more computing devices connected thereto (e.g., system monitoring and adjustment computing platform 110, system 1 120, system 2 130, system N 140, internal data computer system 160, local user computing device 150, and/or local user computing device 155).

Referring to FIG. 1B, system monitoring and adjustment computing platform 110 may include one or more processors 111, memory 112, and communication interface 113. A data bus may interconnect processor(s) 111, memory 112, and communication interface 113. Communication interface 113 may be a network interface configured to support communication between system monitoring and adjustment computing platform 110 and one or more networks (e.g., private network 190, public network 195, or the like). Memory 112 may include one or more program modules having instructions that when executed by processor(s) 111 cause system monitoring and adjustment computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of system monitoring and adjustment computing platform 110 and/or by different computing devices that may form and/or otherwise make up system monitoring and adjustment computing platform 110.

For example, memory 112 may have, store, and/or include a system data module 112a. System data module 112a may store instructions and/or data that may cause or enable the system monitoring and adjustment computing platform 110 to receive, store and/or analyze data from one or more systems, devices, applications, or the like, being monitored by the system monitoring and adjustment computing platform 110. The system data module 112a may receive, for example, a content data stream from one or more systems, devices, applications, and the like, related to a status (e.g., functioning normally, issue detected, or the like), as well as information related to the type of system, device, application, a unique identifier of the system, device and/or application, or the like. This information may extracted from the content data stream and used to determine whether to adjust a monitoring rate (or adjust a time at which monitoring begins, a time interval of monitoring, or the like) of the system, device, application, or the like, based on, for example, a likelihood of an issue arising.

Memory 112 may further have, store and/or include an historical data database 112b. Historical data database 112b may include data related to historical incidents (e.g., issues that occurred previously, have been resolved, or the like) that impacted one or more of the systems being monitored by the system monitoring and adjustment computing platform 110. The data stored in historical data database 112b may be received from a plurality of sources, such as system 1 120, system 2 130, system N 140, internal data computer system 160, and the like. Historical incident data may include a system impacted, a type of incident, a date and time at which the incident occurred, a cause of the incident (if identified), a trigger associated with the incident, or the like. This information may be used by a machine learning engine 112f to generate one or more machine learning datasets.

Memory 112 may further have, store and/or include a scheduler database 112c. The scheduler database 112c may include data related to scheduling of monitoring activities. In some examples, the scheduling database 112c may include data related to current scheduling settings, as well as previous or historical settings for one or more systems, devices, applications, or the like. In some examples, this information may be used by the machine learning engine 112f to generate one or more machine learning datasets.

Memory 112 may further have, store and/or include a service level agreement database 112d. Service level agreement database 112d may include data related to one or more service level agreements (e.g., service level agreements indicating time constraints, government or other body regulations, security requirements, and the like). In some examples, service level agreements may include provisions for timing of file transfers (or completion of file transfers). For instance, one example service level agreement may include a provision for a maximum delay (e.g., one hour, three hours, 90 minutes, or the like) from a time the file arrives at the source. In another example, a service level agreement may include one or more provisions for route destinations, time periods or intervals (e.g., date one to date two), account identifiers eligible to read files originating from certain sources, and the like. This information may be analyzed and used by the machine learning engine 112f to generate one or more machine learning datasets.

Memory 112 may further have, store and/or include a data analysis module 112e. Data analysis module 112e may receive a content data stream from, for example, internal data computer system 160, related to current time of day, day of month, upcoming events (e.g., file transfers, scheduled system maintenance, schedule system updates, and the like), and the like. The data may be received and analyzed by the data analysis module 112e to identify data to be used in generating one or more machine learning datasets. Additionally or alternatively, data extracted from the content data stream of other data may be used with data from the content data stream received from one or more systems to compare to one or more machine learning data sets to, for example, adjust a monitoring rate (or a time at which monitoring begins, a time interval of monitoring, or the like) of the system, device, application, or the like, based on, for example, a likelihood of an issue arising.

Additionally or alternatively, data analysis module 112e may aid in optimizing various functions within the system monitoring and adjustment computing platform. For instance, the data analysis module 112e may analyze data to maximize file transfer success, minimize file transfer disruption or interference, maximize conformance with one or more service level agreements, minimize incidents of alarms transmitted to service technicians, maximize recovery from network events or issues (e.g., failures or other disruptions), and the like.

Memory 112 may further have, store and/or include a machine learning engine 112f and machine learning datasets 112g. Machine learning engine 112f and machine learning datasets 112g may store instructions and/or data that cause or enable system monitoring and adjustment computing platform 110 to determine or predict, in real-time and based on received content, a likelihood that an issue impacting a system, device, application, or the like, will occur causing adjustment of a monitoring rate of the system based on the determination. The machine learning datasets 112g may be based on historical data related to previous system issues, as well as other data related to current date and time, scheduled or upcoming events (e.g., file transfers of files having large file sizes, scheduled maintenance, scheduled updates, and the like).

The machine learning engine 112f may receive data from a plurality of sources and, using one or more machine learning algorithms, may generate one or more machine learning datasets 112g. Various machine learning algorithms may be used without departing from the invention, such as supervised learning algorithms, unsupervised learning algorithms, regression algorithms (e.g., linear regression, logistic regression, and the like), instance based algorithms (e.g., learning vector quantization, locally weighted learning, and the like), regularization algorithms (e.g., ridge regression, least-angle regression, and the like), decision tree algorithms, Bayesian algorithms, clustering algorithms, artificial neural network algorithms, and the like. Additional or alternative machine learning algorithms may be used without departing from the invention. In some examples, the machine learning engine 112f may analyze data to identify patterns of activity, sequences of activity, and the like, to generate one or more machine learning datasets 112g. Additionally or alternatively, the machine learning engine 112f may analyze a frequency of issue occurring. For instance, the machine learning engine 112f may analyze data to determine whether a frequency of a particular issue for a particular system occurred a threshold number of times within a predetermined time period. This information may be used to generate one or more machine learning datasets 112g.

The machine learning datasets 112g may include machine learning data linking one or more identified systems, with particular historical data, other data (e.g., date, time, scheduled file transfer, or the like) to predict a likelihood that an issue with a particular system, device, and/or application may occur and causing adjustment of a monitoring rate associated with the identified system, device and/or application.

Memory 112 may further include monitoring and adjustment module 112h. Monitoring and adjustment module 112h may store instructions and/or data that may cause or enable the system monitoring and adjustment computing platform 110 to compare the received content data streams (e.g., system data, other data, and the like) to one or more machine learning datasets to determine whether a monitoring rate or other setting for an identified system, device, and/or application should be adjusted. In some examples, adjustment of the monitoring rate or other setting may be based on a likelihood that an issue may occur (e.g., system failure or other issue) based on, for example, the comparison.

Adjusting a monitoring rate or other setting for a system, device, and/or application may include adjusting a number of times data from the system is evaluated to determine whether an issue has occurred (e.g., to determine whether the system is functioning within normal or expected operating parameters). Additionally or alternatively, adjusting a monitoring rate or other setting for a system, device, and/or application may include adjusting a time at which monitoring or evaluation of the system begins. For instance, based on the machine learning datasets, the system may determine that issues arising with a particular system generally take two hours to remedy. Accordingly, if the system is scheduled to be operational until a certain hour of the day, the system may adjust the monitoring of the system to begin at the scheduled hour minus two hours to permit sufficient time to remedy any issues that may arise.

In some examples, adjusting a monitoring rate or other setting may include a adjusting a time interval for which a system, device, and/or application is monitored or evaluated. For instance, if morning hours of a typical business day (e.g., Monday-Friday) are identified as critical for a particular application, the monitoring and adjustment module 112h may adjust a monitoring rate to more frequently evaluate the application (e.g., more frequently receive data related to operational performance of the application) during morning business hours Monday through Friday.

Various other examples of adjusting a monitoring rate or other setting may be used without departing from the invention.

Further, as the one or more machine learning datasets are updated and/or validated (as will be discussed more fully below) the monitoring rate for a system, device, and/or application may be further adjusted in order to optimize performance of the systems, devices, and/or applications. This modifying aspect may optimize computing resources by focusing monitoring resources on systems, devices, applications, and the like which are likely to have an issue, while focusing fewer resources on systems, devices, applications, and the like, that are less likely to have an issue.

In some examples, the monitoring and adjustment module 112h may adjust a monitoring rate for systems, devices, applications, and the like, upstream and/or downstream of the system, device or application being evaluated (e.g., from which a content data stream has been received). For instance, based on one or more machine learning datasets, evaluation of a system from which a content data stream is received may indicate that current conditions associated with the system are likely to cause an issue with a system, device or application upstream and/or downstream of the system. Accordingly, the monitoring and adjustment module 112h may adjust a monitoring rate associated with the upstream and/or downstream system based on the evaluation of the system from which the content data stream is received.

Memory 112 may have, store, and/or include a notification generation module 112i. The notification generation module 112i may store instructions and/or data that may cause or enable the system monitoring and adjustment computing platform 110 to generate one or more notifications, transmit the notifications to a system, device, application, user computer device, or the like, and, in some examples, cause the notification to be displayed. The generated notifications may include electronic signals, data packets, a log message, email, short message service, a phone call, or the like. The notifications may be generated and/or transmitted as a system notification in a format or language decipherable by the system (e.g., machine-readable format), or in plain language decipherable by a human user (e.g., user-readable format). In some examples, the notifications may be customizable such that a user may request presentation of particular information. In some examples, the notifications may include one or more commands or instructions to implement one or more actions (e.g., automatically) to avoid or mitigate an issue.

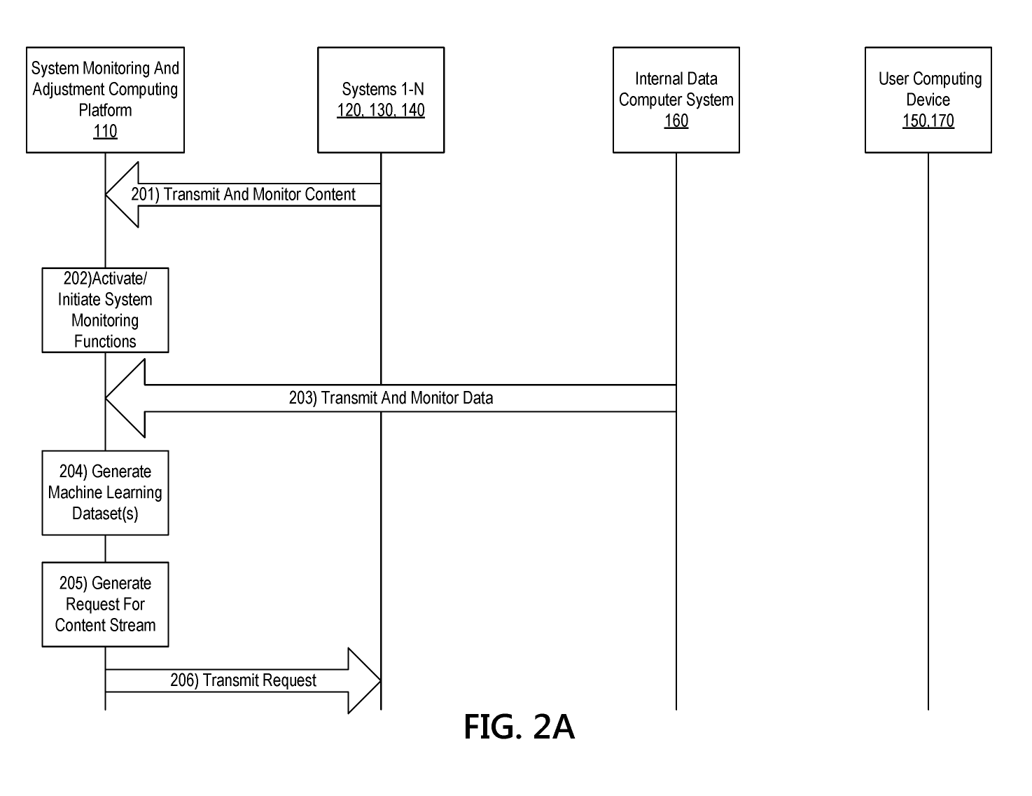

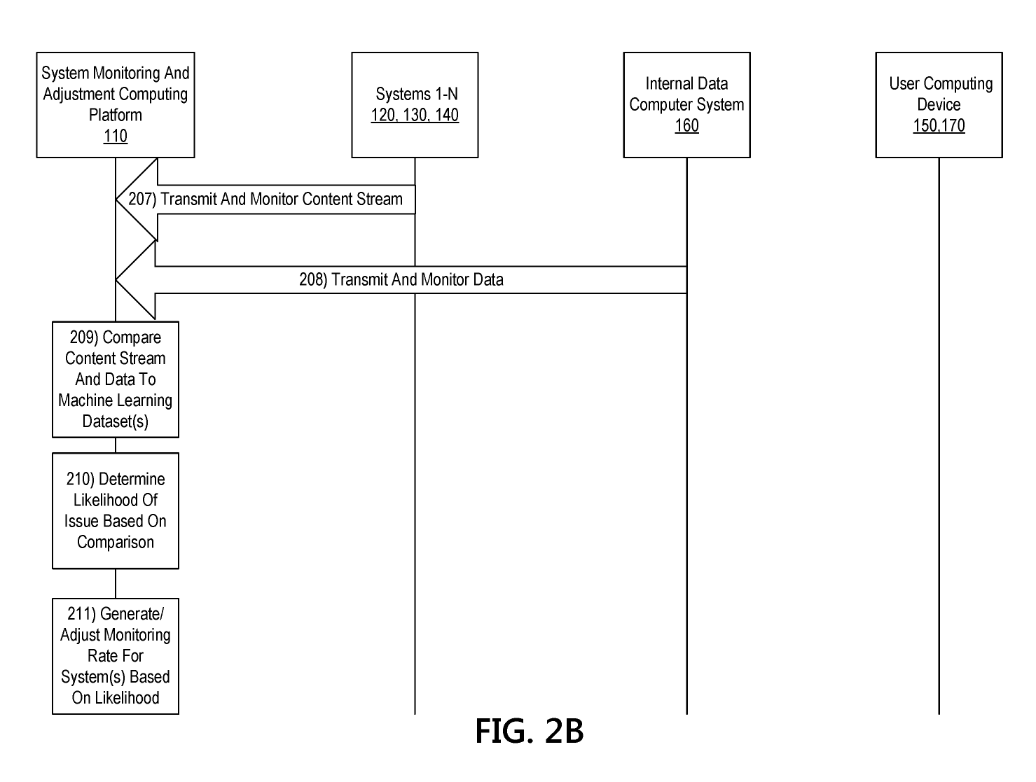

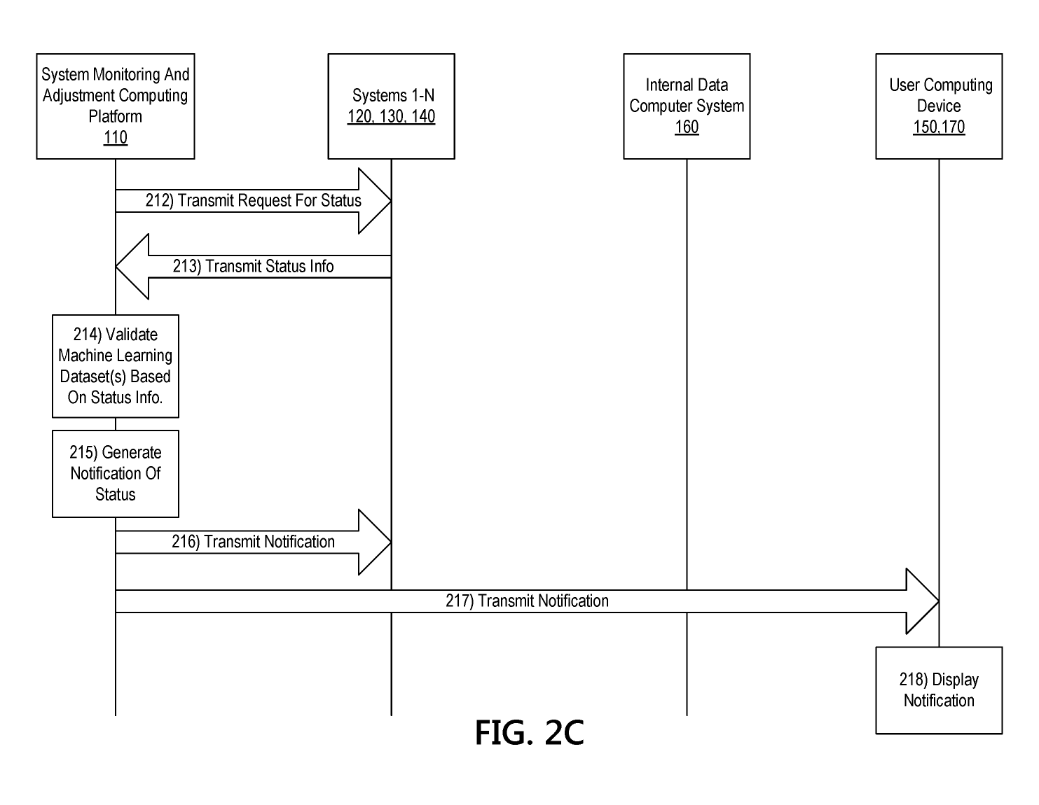

FIGS. 2A-2C depict an illustrative event sequence for implementing and using a data processing system with a machine learning engine to provide system monitoring and adjustment or control functions in accordance with one or more aspects described herein. The events shown in the illustrative event sequence are merely one example sequence and additional events may be added, or events may be omitted, without departing from the invention.

Referring to FIG. 2A, at step 201, content may be received from one or more systems, such as system 1 120, system 2 130, system N 140. As discussed above, systems 120, 130, 140, may be any type of system, device, application, or the like. The content may include data related to a unique identifier associated with the system, current operating conditions of the system, previous operational issues impacting the system and stored at the system, and the like. This information may be stored at the system monitoring and adjustment computing platform 110 (e.g., in historical data database 112b). In some examples, the content data stream may include metadata related to one or more data streams between devices, systems, or the like, in a network. In some examples, the content data stream may include measurements captured at various observation points at various systems, devices, applications, or the like.

In step 202, in response to receiving data from one or more systems, system monitoring and adjustment or control functions may be activated or initiated. For instance, responsive to receiving data from one or more systems, the system monitoring and adjustment computing platform 110 may initiate system monitoring and adjustment or control functions.

In step 203, data may be received from other data sources, such as internal data computer system 160. The data may be related to current date and time, historical data associated with one or more incidents, scheduled file transfers and associated file sizes, previous file transfers and associated file sizes, scheduled updates or maintenance for one or more systems, or the like.

In step 204, the system monitoring and adjustment computing platform 110 may generate one or more machine learning datasets. For instance, the machine learning engine 112f of the system monitoring and adjustment computing platform 110 may receive data from one or more systems 120, 130, 140, internal data computer system 160, and the like, and may generate one or more machine learning datasets. The machine learning datasets may map previous incidents or issues occurring at a system, device or application, to activities occurring at the time of the incident (e.g., a file transfer of a large size), day of the incident, a day of week or month of the incident, whether the issue occurred during a month end period, year end period, or the like, maintenance or update that occurred at or near the time of the incident, and the like. These machine learning datasets may then be used to adjust system monitoring settings based on a likelihood of an issue occurring.

In step 205, the system monitoring and adjustment computing platform 110 may generate a request for a content data stream. The request may be transmitted to one or more system (e.g., systems 120, 130, 140) in step 206.

With reference to FIG. 2B, in step 207, a content data stream may be transmitted from one or more of systems 120, 130, 140 to the system monitoring and adjustment computing platform 110. The content data stream may be received in real-time or near real-time and may include a unique identifier associated with the system, device or application, current operating status of the system, device or application (e.g., is the system, device or application operating within expected operational parameters), and the like.

In step 208, a data may be received from internal data computer system 160. The data may include data related to current date and time, scheduled or anticipated file transfers, associated file sizes and systems involved in the file transfer, upcoming or scheduled maintenance or updates, and the like. In some examples, the data may be received in response to a request transmitted from the system monitoring and adjustment computing platform 110. In other examples, the data may be transmitted at predetermined times, on a periodic basis, or the like.

In step 209, the received content data stream and the received data may be compared to one or more machine learning datasets. In step 210, the system monitoring and adjustment computing platform 110 may determine a likelihood that an issue may occur with an identified system, device or application based on the comparison to the machine learning datasets. For instance, comparing the real-time data with one or more machine learning datasets may identify similarities between one or more systems and the current conditions, and similar conditions found in historical data and used to generate the machine learning datasets.

In step 211, the system monitoring and adjustment computing platform 110 may adjust a monitoring rate associated with one or more systems, devices, or applications based on the determined likelihood of an issue occurring. For instance, if the system monitoring and adjustment computing platform 110 determines that an issue is likely to occur at an identified system, device or application, the monitoring and adjustment module 112h may modify a frequency at which the identified system, device or application is evaluated to determine whether an issue has occurred. In some examples, the time at which evaluation of an identified system, device or application begins may be adjusted based on the determined likelihood. In other examples, the time interval during which the system, device or application is monitored for issues (or frequency of monitoring during the time interval) may be adjusted, and the like.

With reference to FIG. 2C, after a monitoring adjustment has been made (or, based on the comparison, no adjustment is made and the system may be monitored according to a predetermined monitoring setting or rate), the system monitoring and adjustment computing platform 110 may transmit a request for additional data to systems 120, 130, 140, in step 212. The request for additional data may include a request for a current operating status of the system, device or application. In step 213, the requested information may be transmitted from the system to the system monitoring and adjustment computing platform 110.

In step 214, the system monitoring and adjustment computing platform may receive the data and determine whether an issue (e.g., an issue expected based on the determined likelihood generated from the comparison to the machine learning datasets) has occurred. This status information may then be used to validate or update the machine learning dataset used in the comparison.

In step 215, one or more notifications may be generated. The notifications may include an indication of an adjusted monitoring rate or time, a system associated with the adjusted monitoring rate or time, an issue identified at a system, device or application, an expected issue, or the like. In step 216, the generated notification may be transmitted to one or more systems. In step 217, the generated notification may be transmitted to one or more user computing devices, such as local user computing device 150, 155, remote user computing device 170, 175, or the like. Transmission of the notification may include an electronic signal, command or instruction to display the notification on the computing device. In step 218, the system monitoring and adjustment computing platform 110 may cause the notification to be displayed on the computing device.

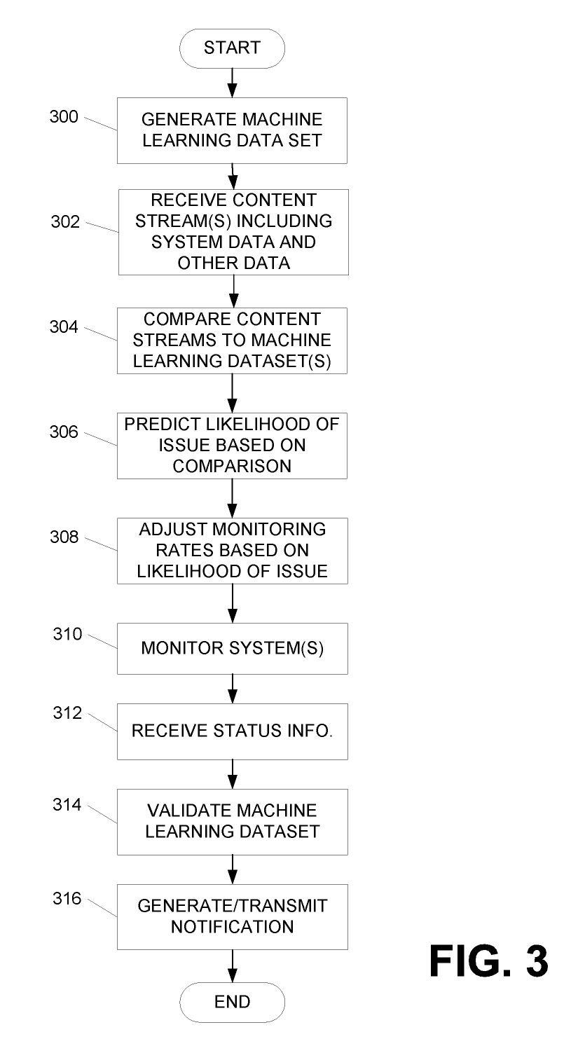

FIG. 3 is a flow chart illustrating one example method of adjusting monitoring controls for one or more systems, devices, applications, or the like, according to one or more aspects described herein. In step 300, one or more machine learning datasets may be generated. The machine learning datasets may be generated based on historical data (e.g., historical issue or incident data from one or more systems), training data (e.g., known patterns, or like), internal system data (e.g., date and time of incidents or issues, scheduled or expected maintenance or updates, and the like), and the like. In some examples, one or more machine learning datasets may be received from one or more external systems or entities.

In step 302, one or more content streams including data from one or more systems, one or more other computing devices (e.g., internal data computer system 160) and the like, may be received. In some examples, the data may be received in real-time or near real-time.

In step 304, the received content streams may be compared to one or more machine learning datasets and, in step 306, a likelihood that an issue may occur may be predicted based on the comparison.

In step 308, a monitoring rate (or monitoring start time, monitoring interval, or the like) may be adjusted based on the predicted likelihood that an issue may occur. In some examples (e.g., examples in which it is determined that an issue is not likely to occur), the system might not adjust a monitoring rate and, instead, may maintain a previous or predetermined monitoring rate, time interval, or the like.

In step 310, one or more systems may be monitored using the adjusted monitoring rate. Monitoring the systems may include transmitting a request for data (e.g., in real-time) to evaluate a current status of the system. In step 312, status information may be received and, in step 314, the status information may be used to validate or update the machine learning dataset.

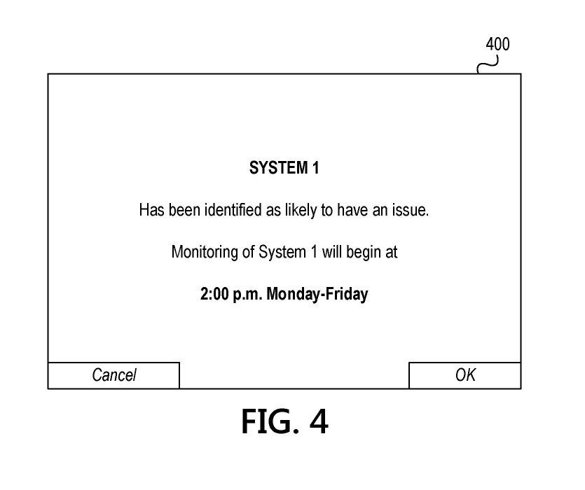

In step 316, one or more notifications may be generated and/or transmitted to a system, user computing device, or the like. FIG. 4 illustrates one example notification that may be transmitted. The notification may be part of a user interface generated by, for example, the notification generation module 112i. The example notification shown is one example notification transmitted to a user computing device, such as local user computing device 150, 155, or remote user computing device 170, 175. As discussed above, other types of notifications in other formats (e.g., machine-readable formats) may be transmitted to one or more systems, as desired).

In some examples, upon conclusion of the process, the process may begin again (e.g., return to step 300). Returning to a start of the process may be performed immediately upon completion of the process (e.g., the process runs in a continual loop), after a lapse of a predetermined amount of time, at a predetermined time, or the like.

The notification 400 includes an identification of the system related to the notification, as well as an indication of the adjustment made to monitoring of the system. Additional or other information may be provided in one or more notifications without departing from the invention.

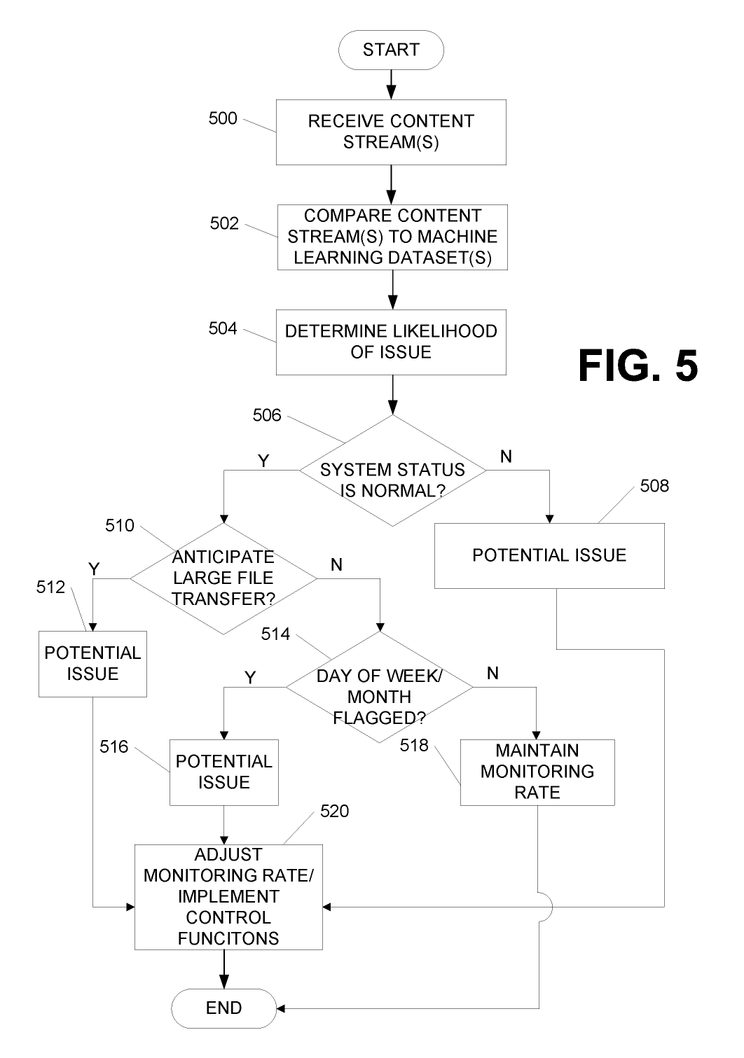

FIG. 5 illustrates one example method of adjusting a monitoring rate based on a predicted likelihood of an issue related to one or more systems, according to one or more aspects described herein. The example method of FIG. 5 may use one or more machine learning engines generated according to one or more aspects described herein.

In step 500, a content stream may be received. The content stream may be received from one or more systems, one or more other computing devices, such as other data computer system 160, and the like. In step 502, the received data and/or content stream may be compared to one or more machine learning datasets, similar to one or more arrangements discussed above.

In step 504, a likelihood of an issue occurring with one or more systems associated with the content data stream may be determined or predicted (e.g., based on the comparison). The determination of a likelihood that an issue may occur may be based on one or more of steps 506-516. For instance, one or more characteristics or features of the current conditions, expected activities, and the like, associated with the system being evaluated may be considered in determining a likelihood that an issue may occur. In some examples, a score may be generated for each feature considered (e.g., 1 or 0) and the scores for each feature may be summed and compared to a threshold score. If at or above the threshold, the system may determine that an issue is likely. If below the threshold, the system may determine that an issue is not likely. Additionally or alternatively, if any of the features evaluated indicate a potential issue, the system may determine that an issue is likely and may adjust monitoring accordingly. Various other arrangements, including scoring arrangements, may be used without departing from the invention.

In step 506, a determination may be made as to whether the operating status of the system being evaluated is within normal or expected operating parameters. If not, the system may be flagged as having a potential issue in step 508. If the system is operating at normal operating parameters, the process may proceed to step 510 where a determination may be made as to whether an activity, such as a transfer of a file having a file size above a predetermined threshold, is scheduled or expected (e.g., based on one or more machine learning datasets). In some examples, the file size threshold may be customizable (e.g., greater than X GB, X MB, or the like).

If a transfer of a file having a size greater than the threshold is expected, the computing platform 110 may flag the system being evaluated as having or anticipating a potential issue in step 512. If an activity such as a file transfer is not anticipated or scheduled, the process may continue to step 514 in which a determination may be made as to whether current data related to day of week, day or month, or the like, is flagged as potential causing an issue for the system. For instance, some systems, devices, applications, or the like, may experience periods of heavy use on a particular day of the week, day of the month, year end, quarter end, month end, or the like. These systems, devices, applications, or the like, may then be flagged as potentially experiencing issues on the flagged days or dates (e.g., in a machine learning dataset). Accordingly, if, in step 514, the current day is flagged, the system may be identified has having or anticipating a potential issue in step 516.

If the current day, date, or the like is not flagged, the current monitoring rate, time interval, or the like may be maintained in step 518. However, in some examples, if any of the features evaluated for the system incurred a flag of a potential issue (e.g., in steps 508, 512, or 516) the monitoring rate, time interval, start time for monitoring, or the like, may be adjusted and/or control functions may be implemented in step 520. For instance, the monitoring rate or other setting may be adjusted and/or one or more notifications may be transmitted, mitigation efforts started, or the like.

In some examples, upon conclusion of the process, the process may begin again (e.g., return to step 500). Returning to a start of the process may be performed immediately (e.g., such that the process is a continual loop), after a lapse of a predetermined time period, at a designated time, or the like.

As discussed herein, the use of machine learning allows the computing platform to efficiently and accurately process vast amounts of data to evaluate historical data, current condition data, and the like, in order to predict a likelihood of a system issue occurring or impacting one or more systems, devices, or applications. Based on the determined likelihood, a monitoring rate or other monitoring setting may be adjusted to enable early detection of any potential issues and quick remediation.

The use of machine learning enables the computing platform to update and/or adjust monitoring settings on a rolling basis. For example, it may be desirable to monitor a system a first time of day on certain days of the week and at a second, different time of day on other days of the week. By updating the machine learning datasets based on the accuracy of the predictions, and evaluating current condition of one or more systems, monitoring settings may be customized for a particular system, device or application, thereby optimizing the available monitoring resources.

The arrangements discussed herein also enable monitoring setting adjustments to be made to systems, devices and/or applications upstream and/or downstream of the system, device, or application being evaluated. For instance, the machine learning datasets may be generated based on data from a plurality of systems, devices, applications, and the like. In generating the machine learning datasets, patterns of impact may be identified. For instance, issues that impact a first system may also impact one or more other systems. These patterns may be built into the machine learning datasets such that the comparison of one or more machine learning datasets to a content data stream may indicate that an issue is likely to occur and that that issue might also impact one or more other upstream and/or downstream devices, systems, or applications. Accordingly, a monitoring rate or other setting may be adjusted for the one or more upstream and/or downstream systems, devices and/or applications.

In some arrangements, the system may be able to transfer or hand-off results to one or more other systems to evaluate upstream/downstream systems, modify upstream/downstream systems, or the like. For instance, in some examples, the system monitoring and adjustment computing platform might not have clearance (e.g., sufficient security clearance or settings) to evaluate systems, events, or the like, occurring at upstream and/or downstream devices, systems, or the like. Accordingly, the system monitoring and adjustment computing platform may transfer interrogation duties to a second system, which may evaluate the upstream and/or downstream systems, devices, events, or the like. In some examples, the second system may implement one or more adjustments. In other examples, the second system may transmit results to the system monitoring and adjustment computing platform to implement one or more adjustments or modifications.

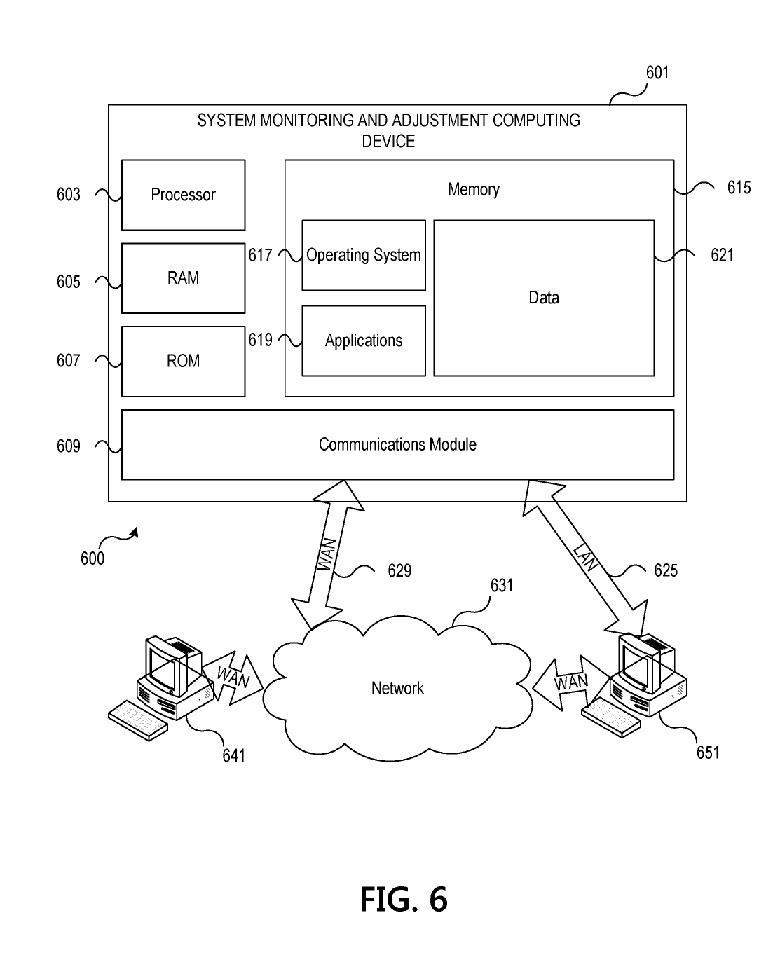

FIG. 6 depicts an illustrative operating environment in which various aspects of the present disclosure may be implemented in accordance with one or more example embodiments. Referring to FIG. 6, computing system environment 600 may be used according to one or more illustrative embodiments. Computing system environment 600 is only one example of a suitable computing environment and is not intended to suggest any limitation as to the scope of use or functionality contained in the disclosure. Computing system environment 600 should not be interpreted as having any dependency or requirement relating to any one or combination of components shown in illustrative computing system environment 600.

Computing system environment 600 may include system monitoring and adjustment computing device 601 having processor 603 for controlling overall operation of system monitoring and adjustment computing device 601 and its associated components, including Random Access Memory (RAM) 605, Read-Only Memory (ROM) 607, communications module 609, and memory 615. System monitoring and adjustment computing device 601 may include a variety of computer readable media. Computer readable media may be any available media that may be accessed by system monitoring and adjustment computing device 601, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by computing device 601.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on system monitoring and adjustment computing device 601. Such a processor may execute computer-executable instructions stored on a computer-readable medium.

Software may be stored within memory 615 and/or storage to provide instructions to processor 603 for enabling system monitoring and adjustment computing device 601 to perform various functions. For example, memory 615 may store software used by system monitoring and adjustment computing device 601, such as operating system 617, application programs 619, and associated database 621. Also, some or all of the computer executable instructions for system monitoring and adjustment computing device 601 may be embodied in hardware or firmware. Although not shown, RAM 605 may include one or more applications representing the application data stored in RAM 605 while system monitoring and adjustment computing device 601 is on and corresponding software applications (e.g., software tasks) are running on system monitoring and adjustment computing device 601.

Communications module 609 may include a microphone, keypad, touch screen, and/or stylus through which a user of system monitoring and adjustment computing device 601 may provide input, and may also include one or more of a speaker for providing audio output and a video display device for providing textual, audiovisual and/or graphical output. Computing system environment 600 may also include optical scanners (not shown). Exemplary usages include scanning and converting paper documents, e.g., correspondence, receipts, and the like, to digital files.

System monitoring and adjustment computing device 601 may operate in a networked environment supporting connections to one or more remote computing devices, such as computing devices 641 and 651. Computing devices 641 and 651 may be personal computing devices or servers that include any or all of the elements described above relative to system monitoring and adjustment computing device 601.

The network connections depicted in FIG. 6 may include Local Area Network (LAN) 625 and Wide Area Network (WAN) 629, as well as other networks. When used in a LAN networking environment, system monitoring and adjustment computing device 601 may be connected to LAN 625 through a network interface or adapter in communications module 609. When used in a WAN networking environment, system monitoring and adjustment computing device 601 may include a modem in communications module 609 or other means for establishing communications over WAN 629, such as network 631 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like and are configured to perform the functions described herein.

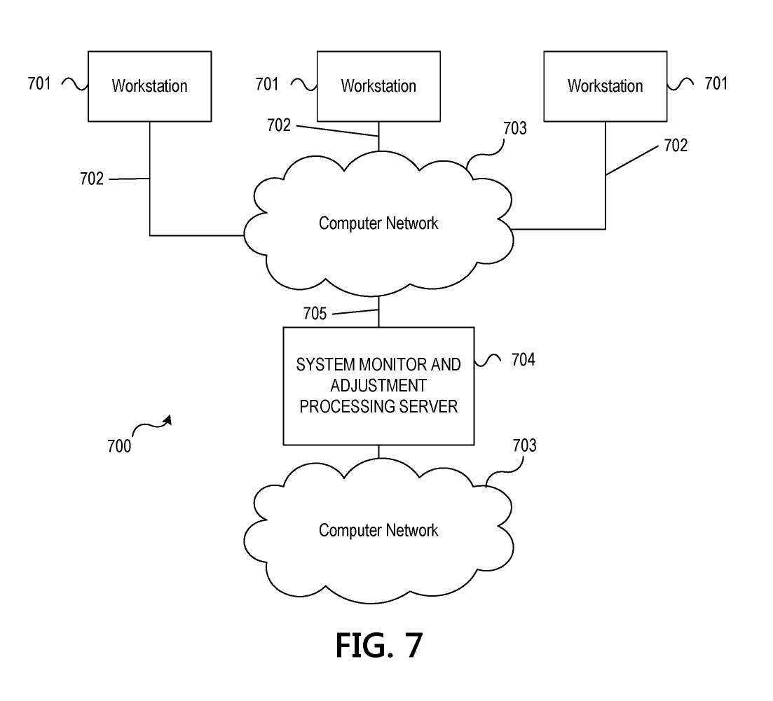

FIG. 7 depicts an illustrative block diagram of workstations and servers that may be used to implement the processes and functions of certain aspects of the present disclosure in accordance with one or more example embodiments. Referring to FIG. 7, illustrative system 700 may be used for implementing example embodiments according to the present disclosure. As illustrated, system 700 may include one or more workstation computers 701. Workstation 701 may be, for example, a desktop computer, a smartphone, a wireless device, a tablet computer, a laptop computer, and the like, configured to perform various processes described herein. Workstations 701 may be local or remote, and may be connected by one of communications links 702 to computer network 703 that is linked via communications link 705 to system monitoring and adjustment processing server 704. In system 700, system monitoring and adjustment processing server 704 may be a server, processor, computer, or data processing device, or combination of the same, configured to perform the functions and/or processes described herein. Server 704 may be used to process received content streams to determine or predict a likelihood of an issue, adjust or modify monitoring rates or other settings, and the like.

Computer network 703 may be any suitable computer network including the Internet, an intranet, a Wide-Area Network (WAN), a Local-Area Network (LAN), a wireless network, a Digital Subscriber Line (DSL) network, a frame relay network, an Asynchronous Transfer Mode network, a Virtual Private Network (VPN), or any combination of any of the same. Communications links 702 and 705 may be communications links suitable for communicating between workstations 701 and system monitoring and adjustment processing server 704, such as network links, dial-up links, wireless links, hard-wired links, as well as network types developed in the future, and the like.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A system monitoring and adjustment computing platform, comprising:
at least one processor;
a communication interface communicatively coupled to the at least one processor; and
memory storing computer-readable instructions that, when executed by the at least one processor, cause the system monitoring and adjustment computing platform to:
receive a content data stream including current condition information related to a plurality of systems;
extract, from the received content data stream, data identifying a system of the plurality of systems and a current condition of the identified system;
responsive to extracting the data, predict, based on a machine learning dataset, a likelihood of a system issue occurring for the identified system; and
adjust, based on the predicted likelihood of a system issue occurring for the identified system, a rate of monitoring a status of the identified system.

2. The system monitoring and adjustment computing platform of claim 1, further including instructions that, when executed, cause the system monitoring and adjustment computing platform to:
receive historical system issue data; and
generate a plurality of machine learning datasets based on the historical system issue data.

3. The system monitoring and adjustment computing platform of claim 1, further including instructions that, when executed, cause the system monitoring and adjustment computing platform to:
receive scheduler data; and
generate a plurality of machine learning datasets based, at least in part, on the scheduler data.

4. The system monitoring and adjustment computing platform of claim 1, further including instructions that, when executed, cause the system monitoring and adjustment computing platform to:
receive service level agreement data; and
generate one or more machine learning datasets based, at least in part, on the service level agreement data.

5. The system monitoring and adjustment computing platform of claim 1, further including instructions that, when executed, cause the system monitoring and adjustment computing platform to:
monitor the identified system based on the adjusted rate of monitoring the status of the identified system;
during the monitoring, receive a current status of the identified system; and
update the machine learning dataset based on the received current status of the system.

6. The system monitoring and adjustment computing platform of claim 1, wherein predicting the likelihood of a system issue occurring for the identified system further includes determining whether the identified system is currently operating within expected parameters based on the received content data stream.

7. The system monitoring and adjustment computing platform of claim 1, wherein predicting the likelihood of a system issue occurring for the identified system further includes determining whether a transfer of a file having a file size greater than a threshold is expected.

8. The system monitoring and adjustment computing platform of claim 1, wherein predicting the likelihood of a system issue occurring for the identified system further includes evaluating at least one of: a current day and a current date to determine whether the at least one of the current day and the current date are flagged.

9. The system monitoring and adjustment computing platform of claim 1, further including instructions that, when executed, cause the system monitoring and adjustment computing platform to:
generate a notification; and
transmit the notification to at least one of: the identified system and a user computing device.

10. The system monitoring and adjustment computing platform of claim 9, wherein the notification is generated in a machine-readable format.

11. The system monitoring and adjustment computing platform of claim 9, wherein the notification is generated in a user-readable format.

12. A method, comprising:
at a computing platform comprising at least one processor, memory, and a communication interface:
receiving, by the at least one processor and via the communication interface, a content data stream including current condition information related to a plurality of systems;
extracting, by the at least one processor and from the received content data stream, data identifying a system of the plurality of systems and a current condition of the identified system;
responsive to extracting the data, predicting, by the at least one processor and based on a machine learning dataset, a likelihood of a system issue occurring for the identified system; and
adjusting, by the at least one processor and based on the predicted likelihood of a system issue occurring for the identified system, a rate of monitoring a status of the identified system.

13. The method of claim 12, further including:
receiving, by the at least one processor, historical system issue data; and
generating, by the at least one processor, a plurality of machine learning datasets based on the historical system issue data.

14. The method of claim 12, further including:
monitoring, by the at least one processor, the identified system based on the adjusted rate of monitoring the status of the identified system;
during the monitoring, receiving, by the at least one processor, a current status of the identified system; and
updating, by the at least one processor, the machine learning dataset based on the received current status of the system.

15. The method of claim 12, wherein predicting the likelihood of a system issue occurring for the identified system further includes determining whether the identified system is currently operating within expected parameters based on the received content data stream.

16. The method of claim 12, wherein predicting the likelihood of a system issue occurring for the identified system further includes determining whether a transfer of a file having a file size greater than a threshold is expected.

17. The method of claim 12, wherein predicting the likelihood of a system issue occurring for the identified system further includes evaluating at least one of: a current day and a current date to determine whether the at least one of the current day and the current date are flagged.

18. The method of claim 12, further including:
generating, by the at least one processor, a notification; and
transmitting, by the at least one processor and via the communication interface, the notification to at least one of: the identified system and a user computing device.

19. The method of claim 18, wherein the notification is generated in a machine-readable format.

20. The method of claim 18, wherein the notification is generated in a user-readable format.

21. One or more non-transitory computer-readable media storing instructions that, when executed by a computing platform comprising at least one processor, memory, and a communication interface, cause the computing platform to:
receive, via the communication interface, a content data stream including current condition information related to a plurality of systems;
extract, from the received content data stream, data identifying a system of the plurality of systems and a current condition of the identified system;
responsive to extracting the data, predict, based on a machine learning dataset, a likelihood of a system issue occurring for the identified system; and
adjust, based on the predicted likelihood of a system issue occurring for the identified system, a rate of monitoring a status of the identified system.

22. The one or more non-transitory computer-readable media of claim 21, further including instructions that, when executed, cause the computing platform to:
receive historical system issue data; and
generate a plurality of machine learning datasets based on the historical system issue data.

23. The one or more non-transitory computer-readable media of claim 21, further including instructions that, when executed, cause the computing platform to:
monitor the identified system based on the adjusted rate of monitoring the status of the identified system;
during the monitoring, receive a current status of the identified system; and
update the machine learning dataset based on the received current status of the system.

24. The one or more non-transitory computer-readable media of claim 21, wherein predicting the likelihood of a system issue occurring for the identified system further includes determining whether the identified system is currently operating within expected parameters based on the received content data stream.

25. The one or more non-transitory computer-readable media of claim 24, wherein predicting the likelihood of a system issue occurring for the identified system further includes determining whether a transfer of a file having a file size greater than a threshold is expected.

26. The one or more non-transitory computer-readable media of claim 25, wherein predicting the likelihood of a system issue occurring for the identified system further includes evaluating at least one of: a current day and a current date to determine whether the at least one of the current day and the current date are flagged.

27. The one or more non-transitory computer-readable media of claim 21, further including instructions that, when executed, cause the computing platform to:
generate a notification; and
transmit the notification to at least one of: the identified system and a user computing device.
